(19) United States
(12) Patent Application Publication
(10) Pub. No.: US 2010/0237643 A1
(43) Pub. Date: Sep. 23, 2010

(54) TRIM FOR WINDOW FRAME OF AUTOMOBILE

(75) Inventor: Jean-Charles Bouillon, La Queue Lez Yvelines (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE BILLANCOURT (FR)

(21) Appl. No.: 12/599,988

(22) PCT Filed: Mar. 21, 2008
(86) PCT No.: PCT/FR08/50497

§ 371 Date: Jan. 5, 2010

(30) Foreign Application Priority Data
May 15, 2007 (FR) 0755084

(51) Int. Cl. B60R 13/02; B21D 53/88

(52) U.S. Cl. 296/1.08; 29/897.2

(57) ABSTRACT

A fitting part on a frame of a window for an automobile, in which the fitting part is a profile including an outer wall connected to an outer face of a sheet-metal member of the frame, and an inner wall including an end bearing against an inner face of the sheet-metal member. The end of the inner wall includes, on the side opposite the sheet-metal member, a bead that can be brought into contact with the sheet-metal member to define a clearance between the end of the inner wall and the sheet-metal member.

The invention relates to a trim arrangement on the window frame of an automobile where the trim is a profile having a first wall fixed to the outer face of a sheet-metal member of the frame and a second wall with an end bearing against an inner face of the sheet-metal member.

An automobile window is bounded by a metal frame on which a trim is mounted on the inner side. The said trim is often made of injection-molded plastic.

The plastic used is often polyamide because of its fluid properties during injection. This material is often reinforced with glass fibers in order to increase its strength. However, the polyamide tends to penetrate into the joining planes of the mold, creating unaesthetic burrs which must then be removed.

As a result, owing to the burring, a zone is formed on the part where the glass fibers protrude from the surface. This burred zone thus become abrasive. Consequently, when this burred zone of the trim rests against the sheet metal of the frame, it tends to act, during displacement, on the paintwork of the frame, resulting in wear of the paintwork and unaesthetic scoring.

In order to overcome this drawbacks, the invention relates to a simple and low-cost trim arrangement on a window frame.

The invention also relates to an associated deburring method.

For this purpose, the invention proposes a trim arrangement on a window frame of the abovementioned type, characterized in that the end of the second wall has, on its side facing the sheet-metal member, a bead suitable for making contact with the sheet-metal member so as to define a clearance between the end of the second wall and the sheet-metal member.

According to other characteristic features of the invention:
the bead has, in the vicinity of the end of the second wall, a substantially flat part;
the clearance between the end of the second wall of the trim and the sheet-metal member is smaller than 0.25 millimeters;
the trim is made of polyamide and contains glass fibers.

The invention also proposes a method for deburring a trim formed by a profile having a wall provided, in the vicinity of its end, with a bead, the said method comprising a first step during which a cutting tool is arranged perpendicularly relative to the end of the wall, bearing against the bead, and a second step during which the tool is displaced along the end of the wall so as to cut off the burrs present on the said end.

Further characteristic features and advantages of the invention will become clear from a reading of the description of examples of embodiment of a trim arrangement on a door frame of an automobile with reference to the accompanying drawings in which:

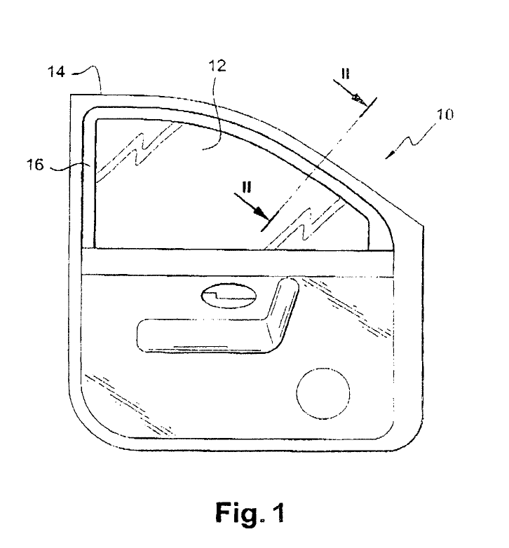

FIG. 1 is a schematic view of a door with the arrangement according to the invention;

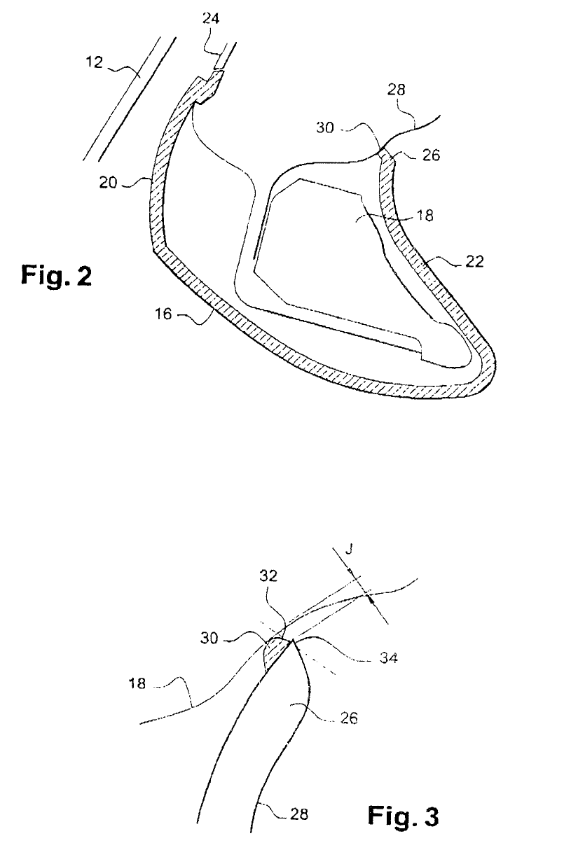

FIG. 2 is a cross-sectional view along the direction II-II of the arrangement shown in FIG. 1;

FIG. 3 is the view of a detail of the arrangement shown in FIG. 2.

As shown in FIG. 1, a door 10 comprises a window 12 and a window frame 14. The window frame 14 is at least partly lined by a trim 16.

As shown in FIG. 2, the trim 16 is a U-shaped profile mounted on a sheet-metal member 18 of the window frame 14. The trim 16 is made of injection-molded plastic such as glass fiber reinforced polyamide 6.6.

The trim 16 has an outer wall 20, situated in the vicinity of the window 14, and an inner wall 22, directed towards the passenger compartment of the vehicle.

The outer wall 20 of the trim 16 is fixed onto an outer face 24 of the sheet-metal member 18, while one end 26 of the inner wall 22 bears against an inner face 28 of the sheet-metal member 18.

The end 26 of the inner wall 22 of the trim 16 may move freely along the inner face 28.

The end 26 of the inner wall 22 has, facing the frame member 18, a bead 30 suitable for bearing against the inner face 28 of the member 18.

As shown in FIG. 3, the bead 30 has, substantially forming an extension of the end 26, a substantially flat face 32.

Thus, when the inner wall 22 of the trim 16 bears against the inner face 28 of the frame member 18, it is the bead 30, and not directly the burred end, which makes contact with the member 18, thus preventing abrasive friction of the end. A clearance J is therefore formed between the end 26 and the member 18.

The clearance J, for aesthetic reasons, is preferably smaller than 0.25 millimeters, but could be larger in size.

In order to perform deburring of the trim 16, a cutting tool is, during a first step, arranged in a direction substantially perpendicular to the plane of the inner wall 22 (direction indicated by a dotted line) and against the flat part 32 of the bead 30; then, during a second step, it is moved along the end 26 so as to cut off any burrs 34.

The bead 30 therefore also facilitates the deburring process.

With the arrangement according to the invention it is thus possible to eliminate the risks of wear and scoring of the paintwork in a simple and low-cost manner, but also without having to modify the design of the window frame.

1-5. (canceled)

6. A trim arrangement on a frame of an automobile window,
in which the trim is a profile including an outer wall fixed to an outer face of a sheet-metal member of the frame and an inner wall with an end bearing against an inner face of the sheet-metal member,
wherein the end of the inner wall includes, on its side facing the sheet-metal member, a bead configured to make contact with the sheet-metal member so as to form a clearance between the end of the inner wall and the sheet-metal member.

7. The trim arrangement as claimed in claim 6, wherein the bead includes, in a vicinity of the end of the inner wall, a substantially flat part.

8. The trim arrangement as claimed in claim 6, wherein a clearance between the end of the inner wall of the trim and the sheet-metal member is less than 0.25 millimeters.

9. The trim arrangement according to claim 6, wherein the trim is made of polyamide and includes glass fibers.

10. A method for deburring a trim formed by a profile having a wall including, in a vicinity of its end, a bead, comprising:
arranging a cutting tool perpendicularly with respect to the plane of the wall, bearing against a flat part of the bead; and
displacing the tool along the end of the wall so as to cut off any burrs present on the end.
